(19) United States
(12) Patent Application Publication
(10) Pub. No.: US 2013/0178243 A1
(43) Pub. Date: Jul. 11, 2013

(54) DISPLAY DEVICE WITH EXTERNALLY-CONNECTED MOBILE COMMUNICATION

(71) Applicant: Chin-Tu TSAI, Taoyuan County (TW)

(72) Inventor: Chin-Tu TSAI, Taoyuan County (TW)

(73) Assignee: HERAN CO., LTD., Taoyuan County (TW)

(21) Appl. No.: 13/486,401

(22) Filed: Jun. 1, 2012

(30) Foreign Application Priority Data
Jan. 6, 2012 (TW) 101200440

(51) Int. Cl. H04W 88/04

(52) U.S. Cl. 455/556.1

(57) ABSTRACT

A display device with externally-connected mobile communication includes a display device, which includes therein a processor unit, and is characterized in that the display device includes a connection port that is connected to the processor unit. The connection port is externally connectable with a SIM (Subscriber Identity Module) device to allow the display device to establish connection with a system of telephone company through the SM device so as to realize mobile communication and wireless network connection.

### BACKGROUND OF THE INVENTION

1. Field of the Invention

The present invention relates to a display device with externally-connected mobile communication, and more particular to an arrangement that uses a connection port of a display device to externally connect a subscriber identity module (SIM) device in order to provide the display device with functions of mobile communication and wireless network connection for applications to various television sets and displays and the likes.

2. Description of Related Art

The process of high technology turns the screen of television set from a cathode ray tube to a liquid crystal display (LCD). However, most the display devices that are provided for household use, either being installed in a living room or a bedroom, are generally used to watch television programs, DVD discs, and also for connection with a computer.

The current trend of the development of household display devices is toward user-friendliness and more and more functions are enabled on the display devices. The most prevailing one is a built-in network connection port, such as RJ-45, so that the display device can be connected via the RJ-45 network connection port to the Internet for network browsing.

However, connection with network may get easily interrupted due to instability of connection line. Consequently, it might need repeated operation of line connection in order to complete transfer of data. This makes the operation very inconvenient. On the other hand, the display device may also be used to monitor housing security, but telecommunication facility and/or network connection lines are often damaged by thieves or burglars before they break in the house, so that immediate transmission of image for security and monitoring purpose is disabled and immediate report of the event to police offices for stopping or catching the thieves is not possibly achieved. This surely leads to severe damage of the householder.

In view such a problem, the present invention aims to provide a display device that is capable of external connection with a an SIM device so as to provide the display device with functions of mobile communication and network connection to allow of easy operation and control by a user.

### SUMMARY OF THE INVENTION

The primary object of the present invention is to provide a display device with externally-connected mobile communication, wherein the display device is provided with a connection port that is connected to a processor unit and the connection port is externally connectable with a SIM device to allow the display device to establish connection with a telephone company through the SM device so as to acquire the functions of mobile communication and wireless network connection thereby improving overall functionality of operation.

Another object of the present invention is to provide a display device with externally-connected mobile communication, which uses a remote control to enter a telephone number to be called to the display device and uses the SIM device to connect to and exchange data with a telephone company thereby improving overall convenience of operation.

A further object of the present invention is to provide a display device with externally-connected mobile communication, which comprises a processor unit that transmits photographed image through a SIM device to a terminal device of a telephone company for further transmission to a remote control unit or a social security unit in order to improve overall utilization of operation.

In order to achieve the foregoing objects, the present invention provides a display device with externally-connected mobile communication, which comprises a display device that comprises therein a processor unit and is characterized in that the display device comprises a connection port that is connected to the processor unit and is externally connectable to a subscriber identity module (SIM) device to allow the display device to establish connection with a telephone company through the SIM device for effecting mobile communication and network connection.

### BRIEF DESCRIPTION OF THE DRAWINGS

The present invention can be fully understood from the following detailed description and preferred embodiment with reference to the accompanying drawings, in which:

FIG. 1 is a perspective view schematically showing the present invention in cabled connection;

FIG. 2 is a perspective view schematically showing the present invention in wireless connection;

FIG. 3 is a block diagram of a structure of the present invention;

FIG. 4 is perspective view schematically illustrating the present invention with a remote control;

FIG. 5 is a block diagram of another structure of the present invention;

FIG. 6 is perspective view illustrating the operation of the present invention identifying burglar invasion; and

FIG. 7 is a perspective view illustrating the operation of the present invention transmitting image of burglar invasion to a telephone company.

### DETAILED DESCRIPTION OF THE PREFERRED EMBODIMENTS

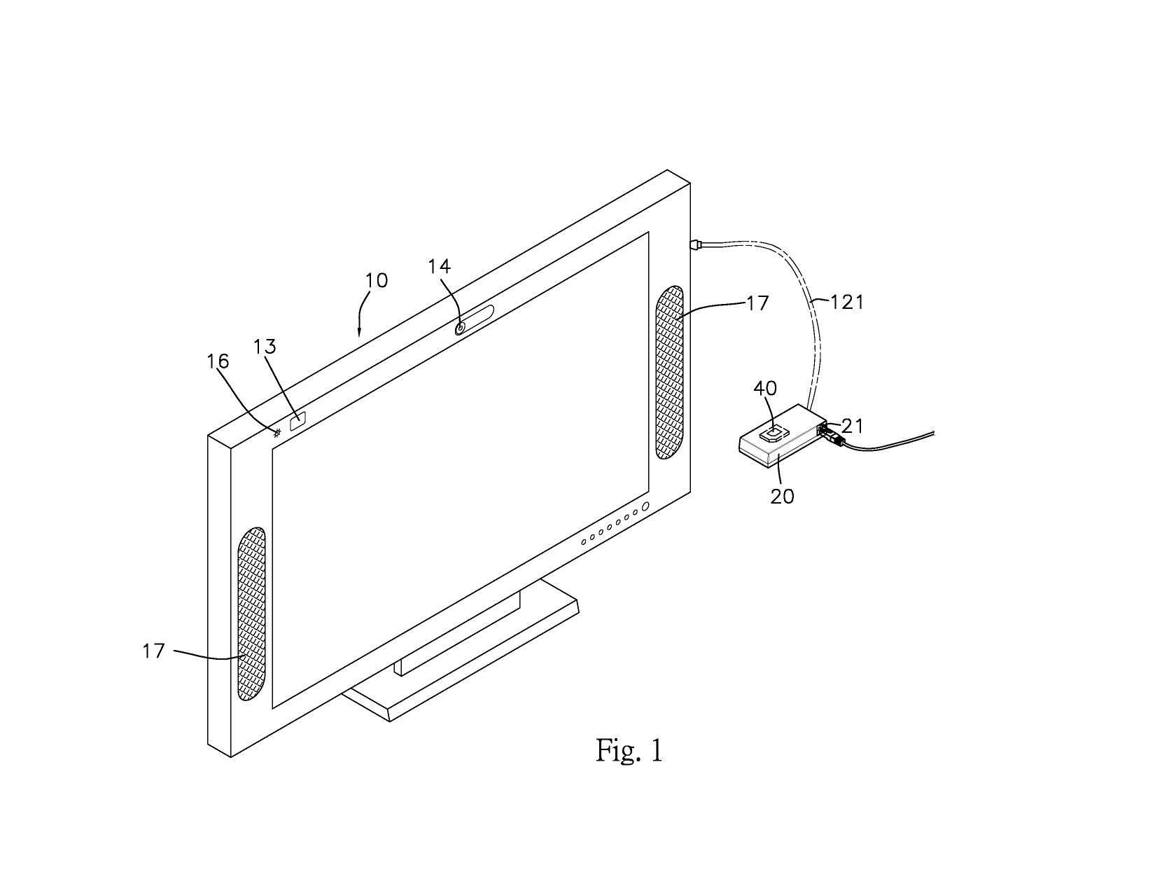

Referring to FIGS. 1-7, the present invention provides a display device with externally-connected mobile communication, which comprises a display device 10. The display device 10 comprises therein a processor unit 11. The present invention is characterized in that the display device 10 comprises a connection port 12 and the connection port 12 is externally connectable with a subscriber identity module (SIM) device 20 to allow the display device 10 to establish connection with a telephone company 50 through the SIM Device 20 in order to proceed with mobile communication and network connection.

The SIM device 20 is provided with a network connection port (RJ-45) 21, whereby the network connection port (RJ-45) 21 allows the display device 10 to connect with a network for browsing. The connection port 12 of the display device 10 is connected through a cable 121 to the SIM device 20. The connection port 12 of the display device 10 can be USB (Universal Serial Bus) or RJ-45. Further, the connection port 12 of the display device 10 is additionally provided with a wireless device so that connection with the SIM device 20 can be established in a wireless manner 122. The SIM device 20 is also provided with a wireless unit 22. The wireless connection 122 can be Bluetooth or Wi-Fi. Further, the display device 10 is further provided with a remote control 30, so that the remote control 30 is enabled to enter a telephone number to be dialed to the display device 10 in order to proceed with connection with and exchange of data with the system of the telephone company 50 through the SIM device 20. Further, the display device 10 is provided with an infrared sensor 13, a camera 14, a memory device 15, and an LED (Light-Emitting Diode) indicator 16. The infrared sensor 13, the camera 14, the memory device 15, and the LED indicator 16 are connected to the processor unit 11 so that photographing and recording household environment can be effected with the camera 14 and the images so photographed can be stored in the memory device 15. When the memory device 15 is activated to store the photographed images, the LED indicator 16 is set on and gives off light. Further, the infrared sensor 13 may function to detect if invasion into the household environment occurs so as to activate the camera 14 to start photographing. The processor unit 11 of the display device 10 transmits the photographed images via the SIM device 20 to a terminal device of the telephone company 50 and the telephone company 50 is connectable with a remote control unit 60 in order to receive the photographed image transmitted from the telephone company 50 and to proceed with remote control operations. The remote control unit 60 can be a mobile phone 61 or a computer 62. Further, the telephone company 50 and the remote control unit 60 can be further connected with a security unit 70 to efficiently supply the received photographed images to the security unit 70 to facilitate protection against crimes. Further, the memory device 15 of the display device 10 may be pre-loaded with a warning voice file 151 so that when the infrared sensor 13 detects invasion, the contents of the warning voice file 151 are retrieved and played with a speaker 17 to provide an effect of deterrence. Further, the display device 10 can be a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), or a video display (TV).

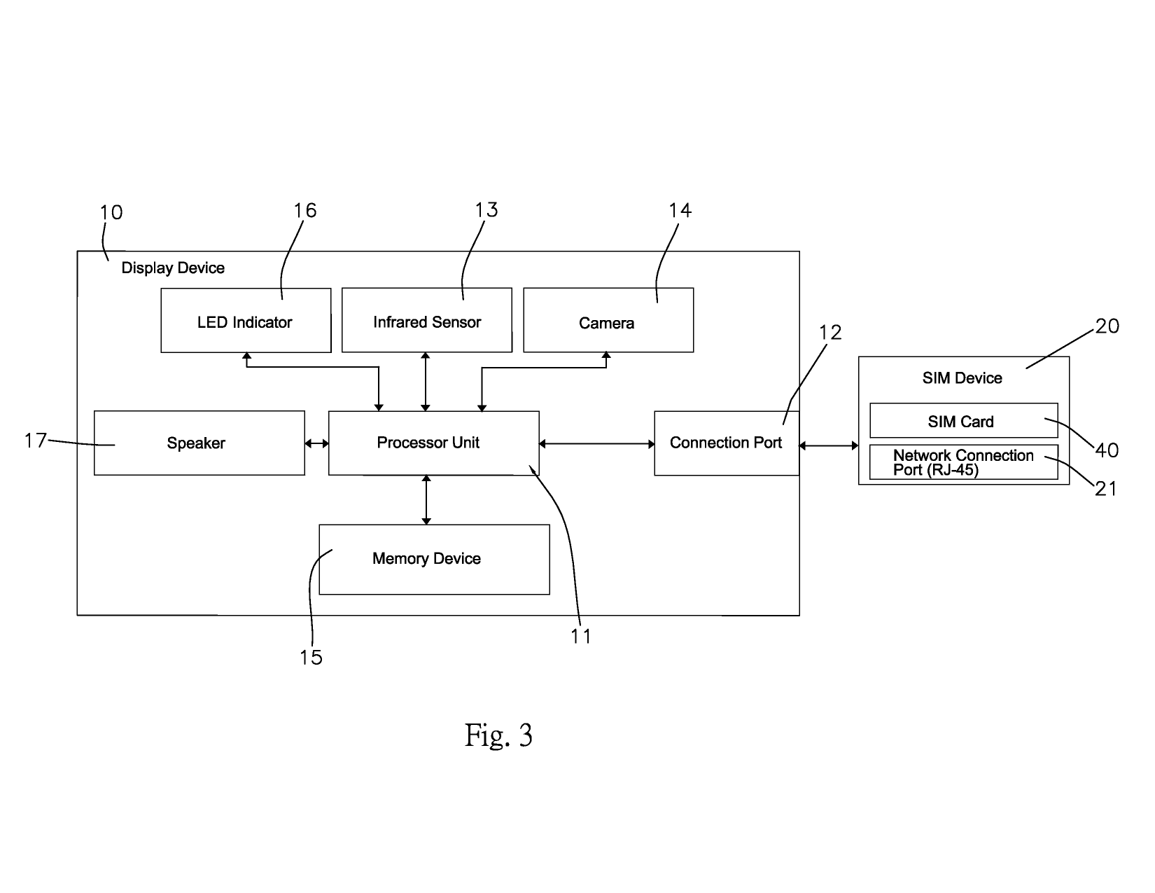

Referring to FIGS. 1-7, the present invention provides a display device with externally-connected mobile communication. A preferred way of embodying the present invention is an application to a display device 10, wherein the display device 10 can be any one of a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV) The video display, which is a television set, can be connected with a signal box for receiving analog signal or digital signal in order to provide a function of watching TV program. The display device 10 according to the present invention comprises therein a processor unit 11 and the display device 10 is provided with a connection port 12 that is connected to the processor unit 11. The connection port 12 is externally connectable to a SIM device 20 (see FIG. 3) to allow the display device 10 to establish connection with a system of a telephone company 50 via the subscriber identity module 20. The subscriber identity module 20 can be loaded with a SIM card 40 issued by any telephone company 50 and the SIM card 40 stores information related to a subscriber. When the SIM card 40 is inserted into the SIM device 20, mobile communication is established for external communication. The SIM card 40 is classified in four types. The first type stores fixed information, which is loaded by a SIM card center before a mobile phone is sold and comprises international mobile subscriber identity (IMSI), key indicator (KI), authentication, enciphering. The second type stores temporary network-related data, such as LAI, TMSI, pay phone network code that prohibits connection. The third type is related to business code, such as PIN, PUK, fair rate. The fourth type is telephone number book, which allows a mobile phone user to enter telephone number. Further, the SIM card 40 is made with A-class enciphering and stores subscriber's data, authentication measure, and key to allow a GSM system to authenticate the user identity and allow the user end to connect to and exchange data with the system.

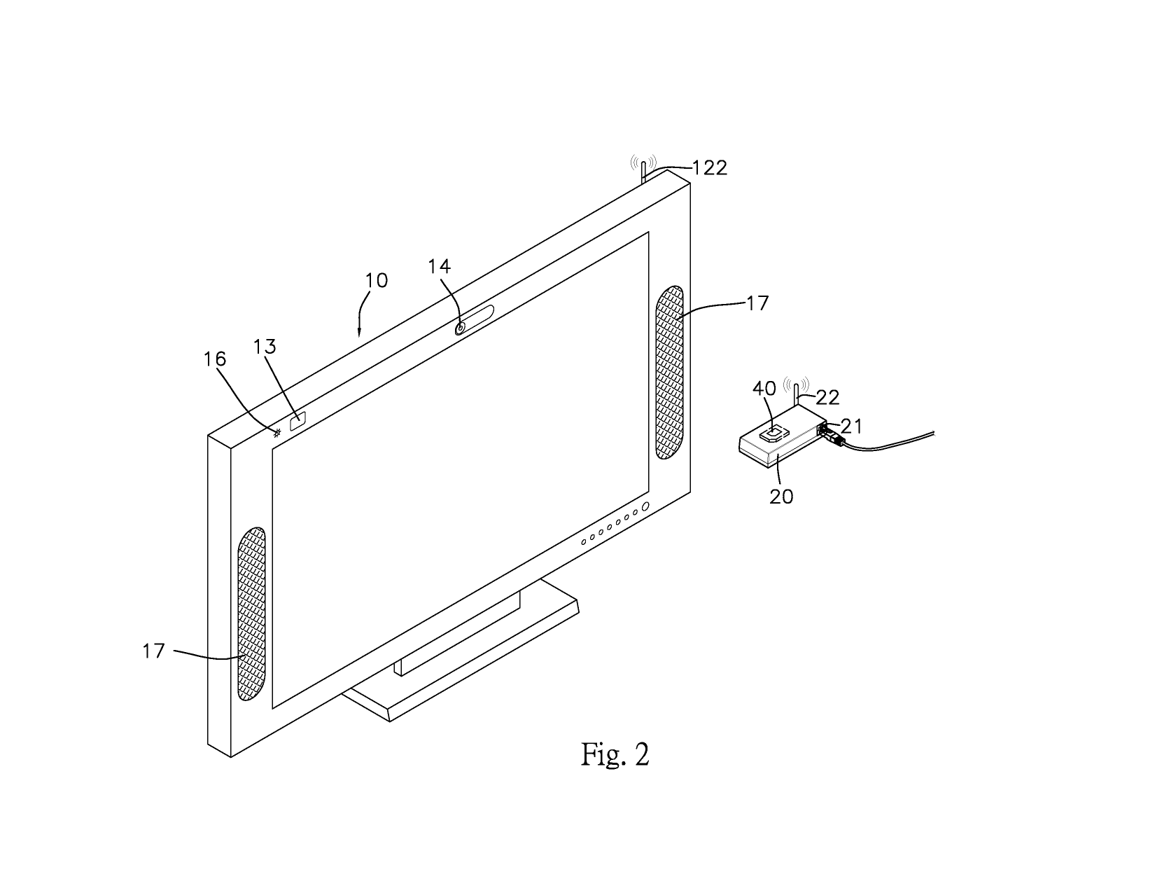

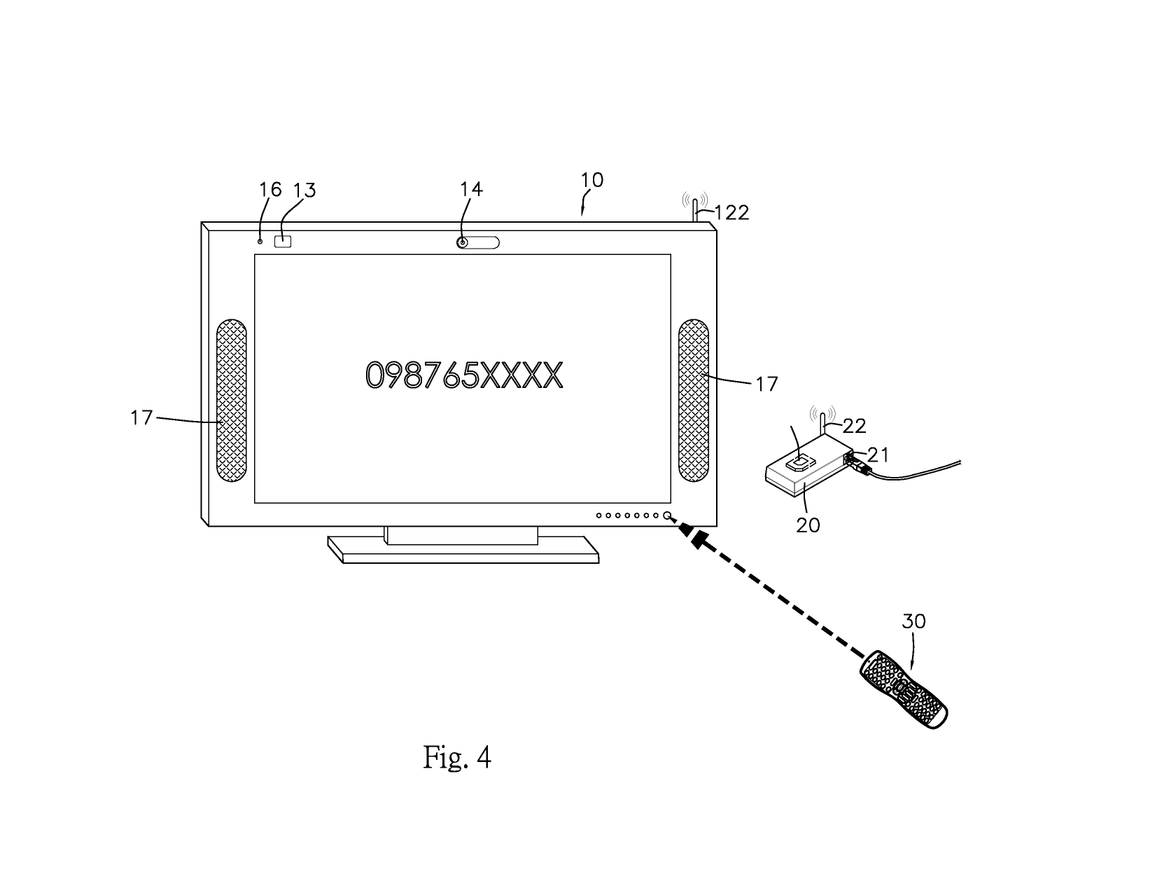

The display device 10 comprises therein a processor unit 11. The processor unit 11 is connected to the connection port 12. The connection port 12 of the display device 10 can be USB or RJ-45 port that is connected by a cable 121 to the SIM device 20 and the SIM device 20 has a function of plug and play function that allows the SIM device 20 to be plugged into the connection port 12 of the display device 10 when used and also allows the SIM device 20 to be removed from the connection port 12 of the display device 10 for storage when not in use. Alternatively, the connection port 12 of the display device 10 is provided with a wireless device, which allows of wireless connection 122 with the SIM device 20. The SIM device 20 is also provided with a wireless device 22 (see FIG. 2). The wireless connection 122 can be Bluetooth or Wi-Fi. The connection between the SIM device 20 and the 10 can be done with these two ways. For both ways, the SIM device 20 is provided with a network connection port (RJ-45) 21 through which the display device 10 is connected to the Internet for browsing and operation. The SIM device 20 is capable of network connection for easy operation and use. Further, the SIM device 20 of the two ways can receive a SIM card 40 of AMPS, GSM, GPRS, 3G, or WiMAX to insert therein so that the display device 10 can establish connection with the system of a telephone company 50 via the SIM device 20 for mobile communication and wireless network connection. The display device 10 enables the use of a remote control 30 to enter a telephone number to be dialed to the display device 10 (see FIG. 4) and the processor unit 11 of the display device 10 connects to and exchange data with the system of the telephone company 50 via the SIM device 20. When the call is connected, voice can be broadcast through a speaker 17 of the display device 10. The display device 10 can be further provided with a microphone (not shown) to allow a user to dialog with the opposite side. Thus, the display device 10 is provided with a function of mobile phone, allowing easy operation at home.

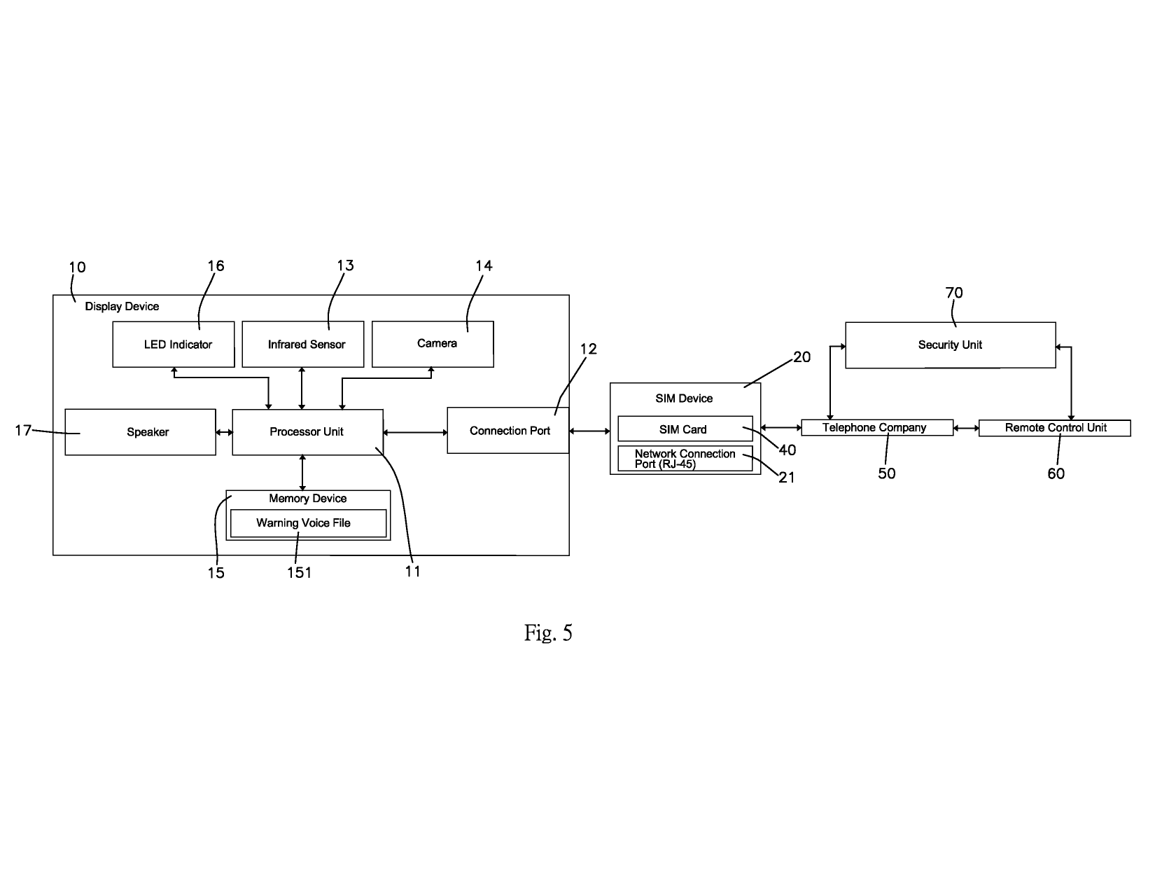

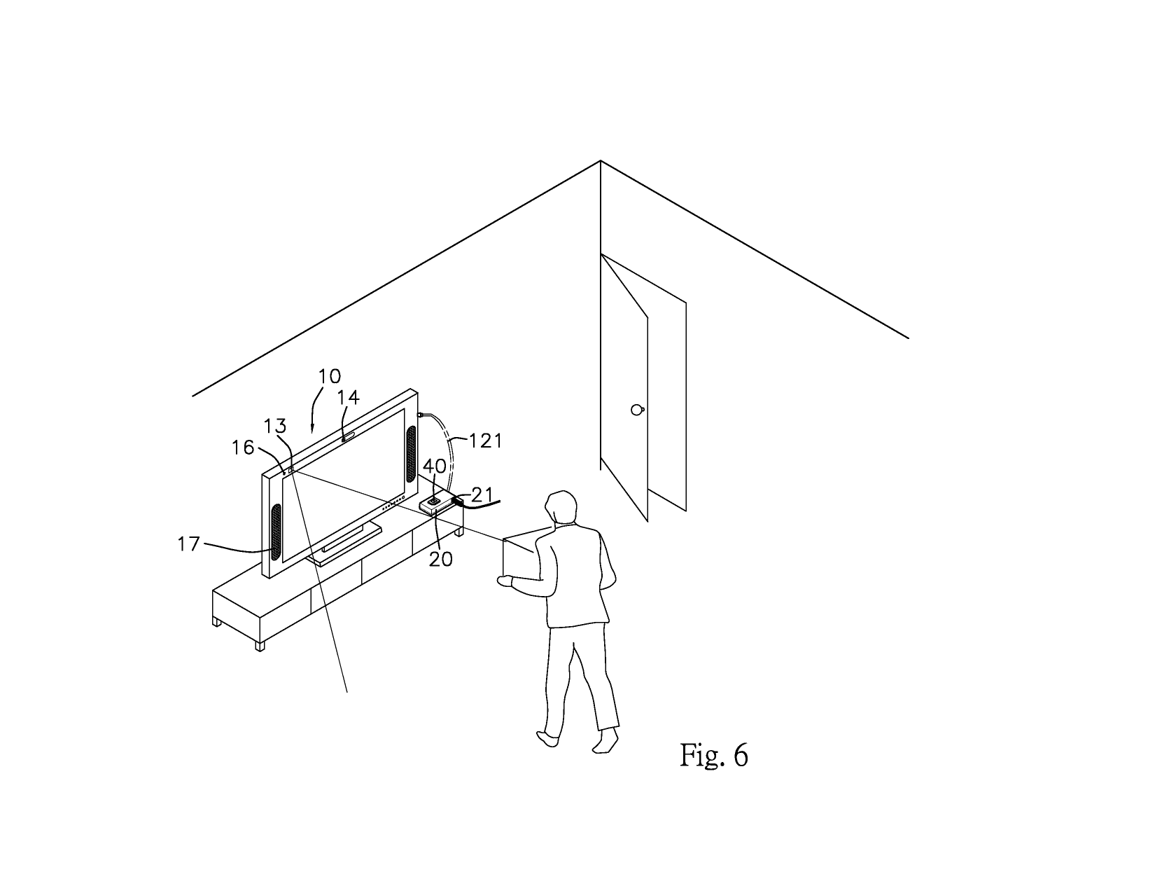

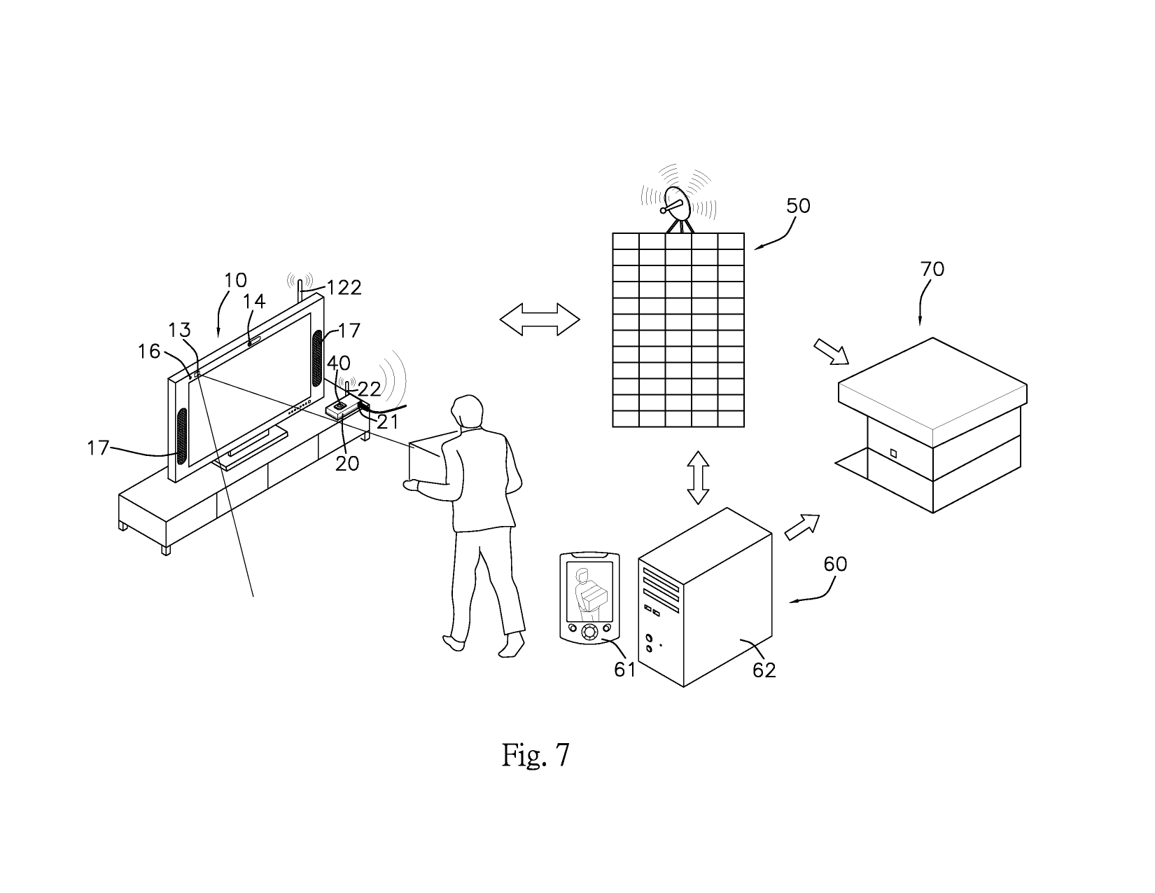

Further, the display device 10 is provided with a camera 14 and the display device 10 comprises therein a processor unit 11. The camera 14 is in signal communication with the camera 14. The processor unit 11 is further connected to a memory device 15 (see FIG. 3 or 5). The memory device 15 can be a hard disk drive (HDD) or a portable memory disc containing flash memory, or a solid state disk (SSD) or the likes. Thus, the display device 10 can be positioned in a living room or a bedroom to work like a television set for watching television program. When the family members are out and unauthorized persons or burglars invade (see FIG. 6), the display device 10 functions like a monitoring device so that the camera 14 of the display device 10 can record the household condition and the recorded images are transmitted through the processor unit 11 to the memory device 15 for storage. The memory device 15 may be provided with instantaneous image compression function to allow the memory device 15 to store more images and the recording process will not be interrupted due to insufficient storage space of the memory device 15. Thus, surveillance of household environment is realized. Further, the display device 10 can be provided with an infrared sensor 13. The infrared sensor 13 is connected to the processor unit 11 of the display device 10. Thus, with the infrared sensor 13 detecting the household environment, when family members are out, the infrared sensor 13 is activated to detect if any invasion occurs. When unauthorized persons or burglars invade and trigger the infrared sensor 13, the infrared sensor 13 supplies a signal through the processor unit to the camera 14 in order to activate the camera 14 for photographing and recoding the event of invasion of the unauthorized persons and the burglars, which is transmitted by the processor unit 11 to the memory device 15 or storage. The display device 10 is provided with an LED indicator 16. The LED indicator 16 is connected to the processor unit 11. When the memory device 15 of the display device 10 starts to record the photographed images, the LED indicator 16 is lit to indicate the operation of storage. The LED indicator 16 is a bi-color light. When the memory device 15 starts a recording operation, the LED indicator 16 gives off light of one color (such as red), and when the recording is completed, the LED indicator 16 normally gives off light of another color (such as green). When a family member comes home and finds the LED indicator 16 is lit, the family member may review the images stored in the memory device 15 through the display device 10 in order to get aware of the image contents that are recorded when the family members are out. Further, connection can be made with the SIM device 20 of the display device 10 to a terminal device or network transmission device of the telephone company 50 so that the images photographed by the camera 14 can be transmitted via the SIM device 20 to the telephone company 50 (see FIG. 7) and the telephone company 50 may further transmit, via a base station, the received images to a remote control unit 60, where in the remote control unit 60 can be a mobile phone 61 or a computer 62 for receiving and displaying the photographed images to allow the family members to immediately realize the current household situation and, when necessary, to inform a security unit 70 (such as a police department or a police station) via the remote control unit 60 or the telephone company 50 so that the security unit 70 can inform police network to investigate the situation, preventing the unauthorized persons or the burglars from committing crimes. Or remote control can be conducted with the remote control unit 60 (such as a mobile phone 61 or a computer 62) so that the remote control unit 60 may be used to transmit a signal, through the telephone company 50, to the display device 10 and further supplied to the processor unit 11 for proceeding with remote controlled operation, such as activating a warning voice file 151 (see FIG. 5) that is stored in the memory device 15 of the display device 10 to broadcast for example “do not trespass and leave immediately” through the speaker 17 of the display device 10 so as to deter the invader away the site immediately thereby achieve an effect of deterrence. Thus, the present invention provides a display device 10 that is provided with functions of mobile communication and wireless network connection through a SIM device 20 and that is further provided with functions of active surveillance and remote control to enhance overall security of household environment.

What is claimed is:

1. A display device with externally-connected mobile communication, comprising a display device, which comprises therein a processor unit, characterized in that the display device comprises a connection port that is connected to the processor unit, the connection port being externally connectable with a SIM device to allow the display device to establish connection with a system of telephone company through the SM device so as to realize mobile communication and wireless network to connection.

2. The display device with externally-connected mobile communication according to claim 1, wherein the SIM device comprises a network connection port whereby the display device is connectable through the network connection port to Internet for browsing.

3. The display device with externally-connected mobile communication according to claim 1, wherein the connection port of the display device is connected by a cable to the SIM device.

4. The display device with externally-connected mobile communication according to claim 1, wherein the display device comprises a wireless device in order to connect to the SIM device in a wireless manner, the SIM device comprising a wireless unit, the wireless manner comprising one of Bluetooth and Wi-Fi.

5. The display device with externally-connected mobile communication according to claim 1, wherein the display device comprises a remote control, which functions to enter a telephone number to be dialed to the display device, whereby connection and exchange of data with the system of telephone company are realized through the SIM device.

6. The display device with externally-connected mobile communication according to claim 1, wherein the display device comprises an infrared sensor, a camera, a memory device, and an LED indicator, and the infrared sensor, the camera, the memory device, and the LED indicator are connected to the processor unit so that photographing and recording household environment is selectively effected with the camera and images so photographed are selectively stored in the memory device whereby when the memory device is activated to store the photographed images, the LED indicator is set on and gives off light; the infrared sensor functions to detect if invasion into household environment occurs so as to activate the camera to start photographing; the processor unit of the display device transmits the photographed images via the SIM device to a terminal device of the telephone company and the telephone company is connectable with a remote control unit in order to receive the photographed image transmitted from the telephone company and to proceed with remote control operations, the remote control unit being a mobile phone or a computer.

7. The display device with externally-connected mobile communication according to claim 6, wherein the telephone company and the remote control unit are connectable with a security unit to efficiently supply the received photographed images to the security unit to facilitate protection against crimes.

8. The display device with externally-connected mobile communication according to claim 6, wherein the memory device of the display device is pre-loaded with a warning voice file so that when the infrared sensor detects invasion, the contents of the warning voice file are retrieved and played with a speaker to provide an effect of deterrence.

9. The display device with externally-connected mobile communication according to claim 1, wherein the display device 10 comprises one of a liquid crystal display (LCD), a thin-film transistor liquid crystal display (TFT-LCD), an organic light-emitting display (OLED), a low temperature poly-silicon (LTPS) display, a projector display (PD), a vacuum fluorescent display (VFD), a plasma display panel (PDP), and a video display (TV).

10. The display device with externally-connected mobile communication according to claim 3, wherein the connection port of the display device is USB (Universal Serial Bus) or RJ-45 to provide cabled connection with the SIM device.
